(19) United States
(12) Patent Application Publication
(10) Pub. No.: US 2011/0019018 A1
(43) Pub. Date: Jan. 27, 2011

(54) Image comprssion system in coordination with camera motion

(75) Inventors: Shi-Wu Lo, Changhua County (TW); Jiun-In Guo, Chiayi County (TW); Tzu-Chun Chang, Taipei City (TW)

Correspondence Address: BACON & THOMAS, PLLC, 625 SLATERS LANE, FOURTH FLOOR, ALEXANDRIA, VA, 22314-1176, US

(73) Assignee: NATIONAL CHUNG CHENG UNIVERSITY, Chia-Yi (TW)

(21) Appl. No.: 12/458,752

(22) Filed: Jul. 22, 2009

(51) Int. Cl. H04N 7/12; H04N 5/228

(52) U.S. Cl. 348/222.1; 348/384.1; 348/E05.031; 348/E07.045

(57) ABSTRACT

An image compression system in coordination with camera motion includes a camera for capturing motion pictures; a motion detection device structurally connected with the camera for detecting motions of the camera; an image compression electrically connected with the camera for compressing the motion pictures; and a motion vector receiver electrically connected with the motion diction device and the image compression device for receiving motion signals generated by the motions and then transmitting the motion signals to the image compression device, whereby the image compression device can refer to the motion signals for calculation while compressing the motion pictures. Accordingly, the image compression system can compress the images in coordination with the camera motion and meanwhile eliminate the minor vibrations in the images.

### BACKGROUND OF THE INVENTION

1. Field of the Invention

The present invention relates generally to image processing technology, and more particularly, to an image compression system in coordination with camera motion.

2. Description of the Related Art

The data bulk of the motion pictures without any compression is very great to need very high bandwidth in file transfer and a great amount of hard drive space in storage, such that the motion pictures are usually compressed for less data bulk. Because the motion pictures are formed of consecutive images, the background of the consecutive images is nearly constant and the landscape is regularly moved. Based on such feature, an image compression manner that is so-called inter prediction coding is available.

Among the video compression standards, block motion estimation is mostly adopted for reducing temporal redundancy. Because the images at the time spot T, between T-1 and T-2, are correlative, a block at the current time spot T can be set as an unit and then the block is compared with the image between T-1 and T-2 within a set search window to locate the most similar block; next, the overlap between the two blocks is cut out to get an error block, and finally it only needs to edit the error block. Due to the analogy of the similar images, the errors converge at zero thereabouts. The more accurate the prediction concludes, the more errors approach zero. For this reason, the fewer bits need edition and thus the compression ratio is enhanced. Wherein, the vector of the motion trajectory is so-called motion vector, and the motion vector can be derived by motion estimation.

The most basic motion estimation can be carried out by a full search algorithm. Within a defined search range in a referential image, search one by one and locate the smallest block of sum of absolute difference (SAD) of the target block and then identify its motion vector. Although such algorithm has higher accuracy, the search time and the operation complexity are also increased. To lower the operation complexity, many fast algorithms are proposed, including three-step algorithm and diamond search algorithm. Since such algorithms belong to the prior art, no more description is necessary.

### SUMMARY OF THE INVENTION

The primary objective of the present invention is to provide an image compression system, which can compress the images in coordination with the camera motion and eliminate the minor vibrations in the images.

The foregoing objective of the present invention is attained by the image compression system composed of a camera, a motion detection device, an image compression device, and a motion vector receiver. The motion detection device is structurally connected with the camera for detecting motions of the camera. The image compression is electrically connected with the camera for compressing motion pictures captured by the camera. The motion vector receiver is electrically connected with the motion diction device and the image compression device for receiving motion signals generated by the motions detected by the motion detection device and then transmitting the motion signals to the image compression device, whereby the image compression device can refer to the motion signals for calculation while compressing the motion pictures.

### BRIEF DESCRIPTION OF THE DRAWINGS

FIG. 1 is a schematic view of a first preferred embodiment of the present invention in structure.

FIG. 2 is a schematic view of the first preferred embodiment of the present invention in operation.

FIG. 3 is a schematic view of a second preferred embodiment of the present invention in structure.

FIG. 4 is a schematic view of a third preferred embodiment of the present invention in structure.

FIG. 5 is a schematic view of a fourth preferred embodiment of the present invention.

### DETAILED DESCRIPTION OF PREFERRED EMBODIMENTS

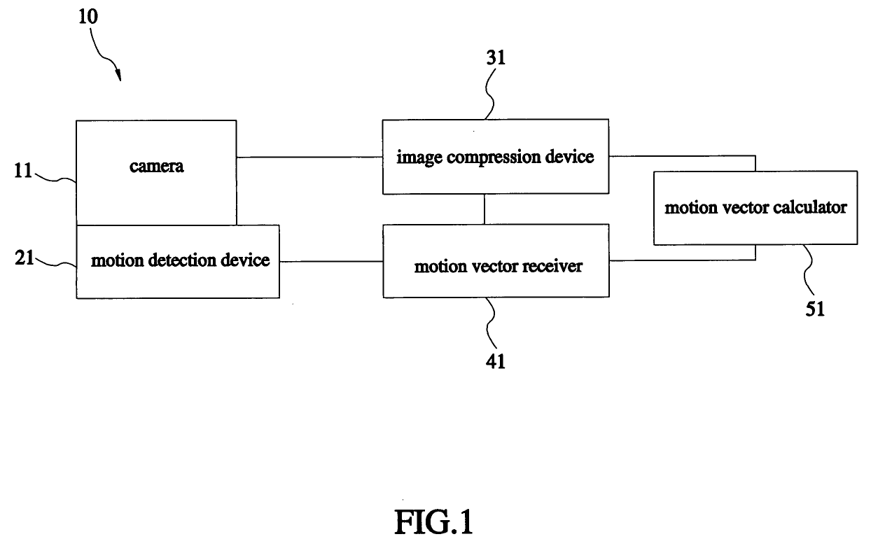

Referring to FIG. 1, an image compression system 10 in coordination with camera motion in accordance with a first preferred embodiment of the present invention is composed of a camera 11, a motion diction device 21, an image compression device 31, a motion vector receiver 41, and a motion vector calculator 51.

The camera 11 is adapted for capturing motion pictures of a target scene or article.

The motion detection device 21 is structurally connected with the camera 11 for detecting motions of the camera 11. The motion detection device 21 is a gravity sensor (G-sensor), a gyroscope, a global positioning system (GPS), a radio frequency identification (RFID), a mechanical measurement device (like scale or angle gauge), or an ultrasonic positioning device.

The image compression device 31 is electrically connected with the camera 11 for compressing the motion pictures captured by the camera 11.

The motion vector receiver 41 is electrically connected with the motion detection device 21 and the image compression device 31 for receiving motion signals generated by the motions detected by the motion detection device 21 and then for transmitting the motion signals to the image compression device 31. The image compression device can refer to the motion signals for calculation while compressing the motion pictures.

The motion vector calculator 51 is electrically connected with the motion vector receiver 41 and the image compression device 31 for assisting the image compression device 31 in enhancing compression rate or decreasing the complexity of calculation of motion vector.

By reference to the data received by the motion vector receiver 41, the image compression device 31 eliminates minor vibrations in the images while compressing the same. Those minor vibrations include human body's tremors or mechanical device's trembles. The images having the minor vibrations and needing cutout are deleted and replaced by similar ones for stable motion pictures.

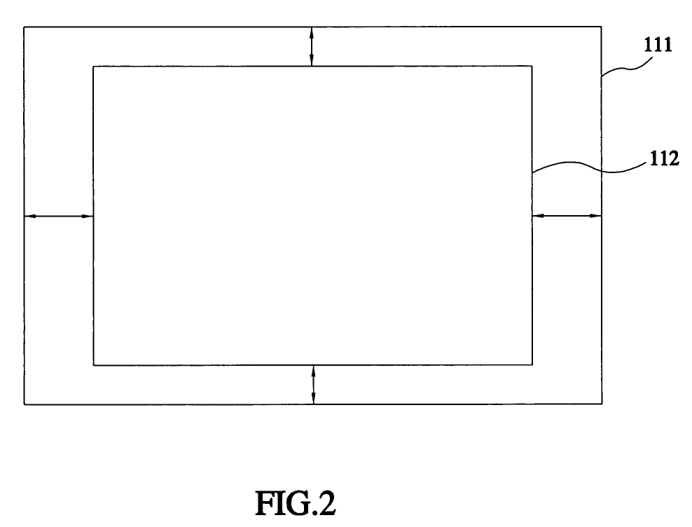

As shown in FIGS. 1-2, among the motion pictures captured by the camera 11, original motion pictures 111 are larger than actual motion pictures 112. The image compression device 31 carries out calculation based on the motions detected by the motion detection device 21 and then picks invariable parts of the original motion pictures 111 for output of the actual motion pictures 112.

How the image compression system 10 works is recited below.

When the camera 11 captures the motion pictures, the motion detection device 21 detects the motions of the camera 11 and then the motion vector receiver 41 receives the data about the motions. Next, the image compression device 31 carries out calculation of the compression of the motion pictures by reference to the data. In the meantime, the minor vibrations, like hand shaking, of the motion pictures are eliminated. Then, the motion vector calculator 51 provides the calculation of high compression rate or decreases the complexity of calculation of the motion vector.

In light of the above, in addition to enhancing the compression rate of the motion pictures, the present invention is anti-vibration to eliminate the user's natural tremors for stable motion pictures.

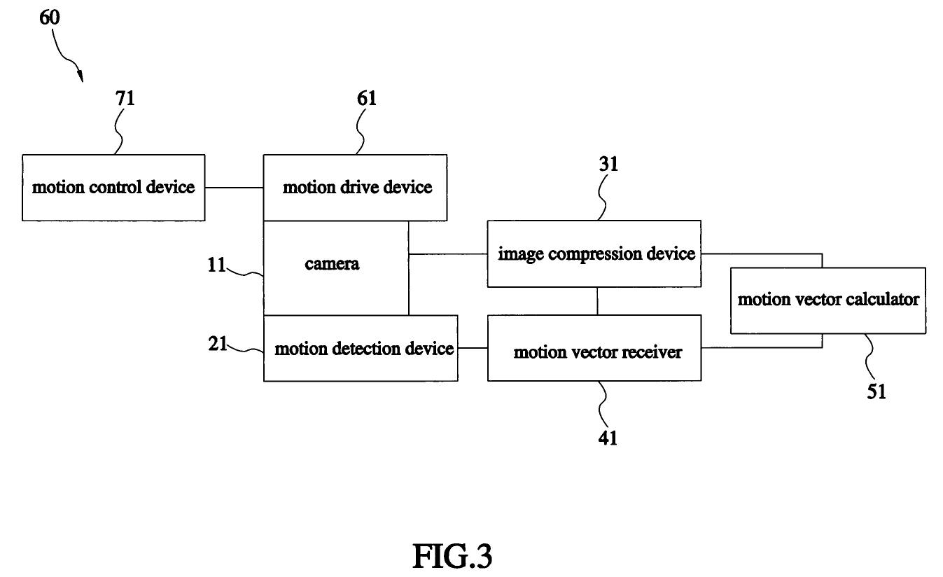

Referring to FIG. 3, an image compression system 60 in coordination with camera motion in accordance with a second preferred embodiment of the present invention is similar to that of the first embodiment, having the following difference.

The image compression system 60 further includes a motion drive device 61 and a motion control device 71. The motion drive device 61 is structurally connected with the camera 11 for driving the camera 11 to move. The motion drive device 61 is a mechanical arm, a mechanical turntable, or a self-propelled device. The motion control device 71 is electrically connected with the motion drive device 61 for controlling the motion drive device 61 and further the motions of the camera 11. The motion control device 71 is a programmable control chip in this embodiment.

The operation of the second embodiment of the present invention is similar to that of the first embodiment but different as recited thereafter. The user controls the motion drive device 61 via the motion control device 71 for motion to further drive the camera 11 to move corresponding to the motion of the camera 11 so as to comply with the requirement for motion of the camera 11 as set by the user. The motions generated by the motion drive device 61 can be converted into signals and then transmitted to the motion vector calculator 51 via the motion control device 71 or the motion detection device 21 for the basis of calculation of motion vector. The motion control device 71 can convert the motions of the camera 11 into digital or analogical signals and then transmit the signals to the motion vector calculator 51. As for other operational details, like image compression and anti-vibration, they have been disclosed in the first embodiment and thus can be omitted.

Therefore, the present invention can compress the motion pictures and meanwhile eliminate their minor vibrations by detecting the motions of the camera 11, thus having double functions of image compression and vibration reduction.

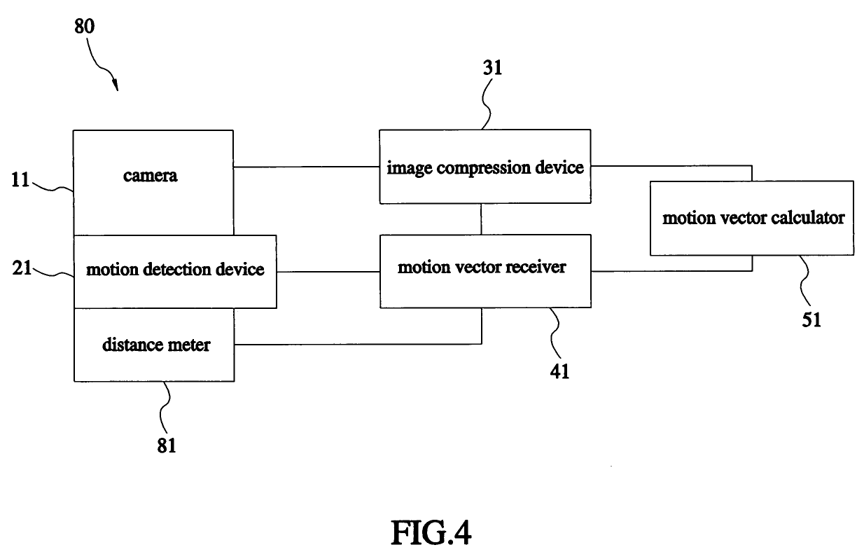

Referring to FIG. 4, an image compression system 80 in coordination with camera motion in accordance with a third preferred embodiment of the present invention is similar to that of the first embodiment, having the following difference.

The image compression system 80 further includes a distance meter 81 electrically connected with the motion vector calculator 51 for measuring the distance between the camera 11 and the target scene or article whose motion pictures are being captured by the camera 11. The distance meter 81 is structurally connected with the camera 11. The distance meter 81 is a secondary photographing device, a sound-ranging device, a sonar-ranging device, a radar-ranging device, an optical ranging device, or a coordinate photographing device. Among them, the sound-ranging device, the sonar-ranging device, the radar-ranging device, and the optical ranging device are well known for the person skilled in the art, such that they do not need more recitation. As for the coordinate photographing device, together with the camera 11, it can constitute 3D photograph or strengthen image quality.

Acquisition of the distance between the camera 11 and the target scene or article and calculation done by the motion vector calculator 51 can work out more accurate motion vector to assist the image compression device 31 in enhancing compression rate or image quality by reference to the information regarding the distance.

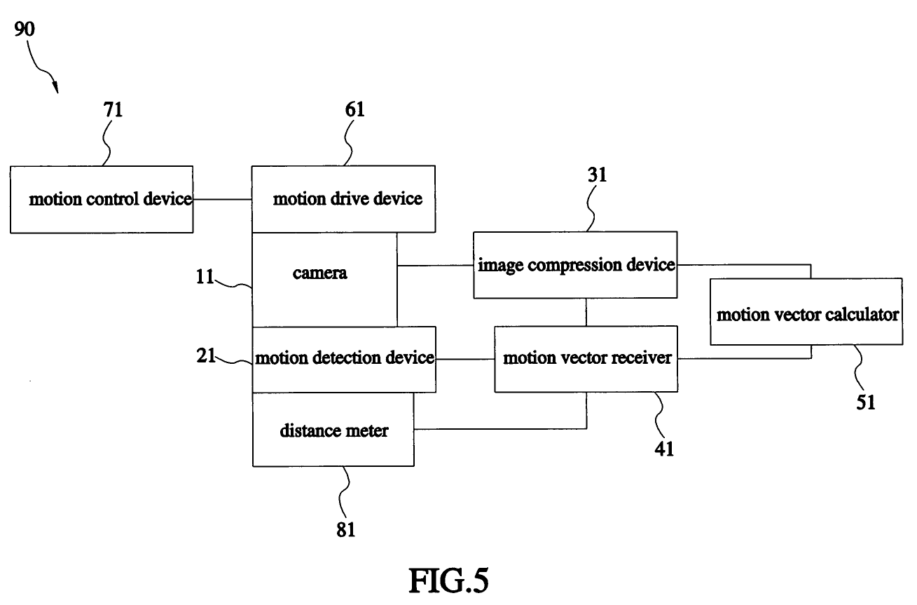

Referring to FIG. 5, an image compression system 90 in coordination with camera motion in accordance with a fourth preferred embodiment of the present invention is similar to that of the second embodiment, having the following difference.

The mage compression system 90 further includes a distance meter 81, which is identical to that of the third embodiment. The distance meter 81 of this embodiment likewise provides additional distance information to further assist the image compression device 31 in enhancing the image compression rate or the image quality. No more recitation of the distance meter 81 of this embodiment is necessary because it reaches the same effect as that of the third embodiment does.

Although the present invention has been described with respect to specific preferred embodiments thereof, it is no way limited to the details of the illustrated structures but changes and modifications may be made within the scope of the appended claims.

What is claimed is:

1. An image compression system in coordination with camera motion, comprising:
a camera for capturing motion pictures;
a motion detection device structurally connected with the camera for detecting motions of the camera and converting the motions of the camera into motion signals;
an image compression device electrically connected with the camera for compressing the motion pictures captured by the camera; and
a motion vector receiver electrically connected with the motion detection device and the image compression device for receiving the motion signals from the motion detection device and transmitting the motion signals to the image compression device, whereby the image compression device can refer to the motion signals for calculation of the compression of the motion pictures.

2. The image compression system as defined in claim 1, wherein the motion detection device is a G-sensor, a gyroscope, a GPS, an RFID, a mechanical measurement device, or an ultrasonic positioning device.

3. The image compression system as defined in claim 1 further comprising a motion vector calculator, wherein the motion vector calculator is electrically connected with the motion vector receiver and the image compression device for assisting the image compression device in enhancing compression rate or reducing complexity of calculation of motion vector.

4. The image compression system as defined in claim 3 further comprising a distance meter, wherein the distance meter is electrically connected with the motion vector calculator for measuring the distance between the camera and a target scene or article whose motion pictures are being captured by the camera.

5. The image compression system as defined in claim 4, wherein the distance meter is structurally connected with the camera, and the distance meter is a secondary photographing device, a sound-ranging device, a sonar-ranging device, a radar-ranging device, an optical ranging device, or a coordinate photographing device.

6. The image compression system as defined in claim 1, wherein the image compression device eliminates minor vibrations in the motion pictures by reference to data of the motion signals received by the motion vector receiver while compressing the motion pictures, the minor vibrations comprising human body's natural tremors or mechanical device's trembles.

7. The image compression system as defined in claim 6, wherein the motion pictures captured by the camera are larger than actual output ones, and the image compression device carries out calculation based on the motions detected by the motion detection device and then picks invariable parts of the larger motion pictures for output of the actual output motion pictures.

8. The image compression system as defined in claim 6, wherein the image compression device needs to delete the motion pictures, which must be cut out due to the minor vibrations, and then to replace those motion pictures with similar ones for stable motion pictures.

9. An image compression system in coordination with camera motion, comprising:
a camera for capturing motion pictures;
a motion drive device structurally connected with the camera for driving motions of the camera;
a motion control device electrically connected with motion drive device for controlling the motion drive device for further controlling manners of the motions of the camera;
a motion detection device structurally connected with the camera for detecting the motions of the camera and converting the motions of the camera into motion signals;
an image compression device electrically connected with the camera for compressing the motion pictures captured by the camera; and
a motion vector receiver electrically connected with the motion detection device and the image compression device for receiving the motion signals from the motion detection device and transmitting the motion signals to the image compression device, whereby the image compression device can refer to the motion signals for calculation of the compression of the motion pictures.

10. The image compression system as defined in claim 9, wherein the motion detection device is a G-sensor, a gyroscope, a GPS, an RFID, a mechanical measurement device, or an ultrasonic positioning device.

11. The image compression system as defined in claim 9 further comprising a motion vector calculator, wherein the motion vector calculator is electrically connected with the motion vector receiver and the image compression device for assisting the image compression device in enhancing compression rate or reducing complexity of calculation of motion vector.

12. The image compression system as defined in claim 11 further comprising a distance meter, wherein the distance meter is electrically connected with the motion vector calculator for measuring the distance between the camera and a target scene or article whose motion pictures are being captured by the camera.

13. The image compression system as defined in claim 11, wherein the distance meter is structurally connected with the camera, and the distance meter is a secondary photographing device, a sound-ranging device, a sonar-ranging device, a radar-ranging device, an optical ranging device, or a coordinate photographing device.

14. The image compression system as defined in claim 11, wherein the motion control device can convert the manners of the motions of the camera into digital or analogical signals and then transmit those signals to the motion vector calculator.

15. The image compression system as defined in claim 9, wherein by reference to data of the motion signals of the motion vector receiver, the image compression device eliminates minor vibrations in the motion pictures while compressing the motion pictures, the minor vibrations comprising human body's natural tremors or mechanical device's trembles.

16. The image compression system as defined in claim 15, wherein the motion pictures captured by the camera are larger than actual output ones, and the image compression device carries out calculation based on the motions detected by the motion detection device and then picks invariable parts of the larger motion pictures for output of the actual output motion pictures.

17. The image compression system as defined in claim 15, wherein the image compression device needs to delete the motion pictures, which must be cut out due to the minor vibrations, and then to replace those motion pictures with similar ones for stable motion pictures.

18. The image compression system as defined in claim 9, wherein the motion drive device is a mechanical arm or a mechanical turntable or a self-propelled device.

19. The image compression system as defined in claim 9, wherein the motion control device is a programmable control chip.
